(19) United States
(12) Patent Application Publication
(10) Pub. No.: US 2023/0049788 A1
(43) Pub. Date: Feb. 16, 2023

(54) DATA TRANSMISSION METHOD, APPARATUS, AND DEVICE

(71) Applicant: HUAWEI TECHNOLOGIES CO., LTD., Shenzhen (CN)

(72) Inventors: Bin XU, Beijing (CN); Bingzhao LI, Beijing (CN); Lei CHEN, Beijing (CN); Haifeng YU, Beijing (CN)

(73) Assignee: HUAWEI TECHNOLOGIES CO., LTD., Shenzhen (CN)

(21) Appl. No.: 17/975,916

(22) Filed: Oct. 28, 2022

Related U.S. Application Data
(63) Continuation of application No. PCT/CN2021/075803, filed on Feb. 7, 2021.

(30) Foreign Application Priority Data
Apr. 30, 2020 (CN) 202010368405.6

(51) Int. Cl. H04W 4/06; H04W 40/02; H04L 45/74

(52) U.S. Cl. CPC H04W 4/06; H04W 40/02; H04L 45/74; H04L 12/189

(57) ABSTRACT

This application provides for a data transmission method, an apparatus, and a device. The method may be applied to a relay communication system. The method includes a first network device that receives a first data packet. The first data packet is a data packet of a first multimedia broadcast multicast service (MBMS), and the first data packet carries first information. When second information of the first network device matches the first information, the first network device sends the first data packet to a terminal device that accesses the first network device. The second information is preconfigured for the first network device. In this way, the MBMS is transmitted in the relay communication system.

### CROSS-REFERENCE TO RELATED APPLICATIONS

This application is a continuation of International Application No. PCT/CN2021/075803, filed on Feb. 7, 2021, which claims priority to Chinese Patent Application No. 202010368405.6, filed on Apr. 30, 2020. The disclosures of the aforementioned applications are hereby incorporated by reference in their entireties.

### TECHNICAL FIELD

This application generally relates to the field of wireless communication technologies, and in particular, to a data transmission method, an apparatus, and a device.

### BACKGROUND

In 5G telecommunication technologies (5th generation mobile communication technology), to cope with an explosive growth of mobile data traffic and massive device connections in the future, and to meet emerging new services and application scenarios, a base station (gNB) may use a central node-distributed node (e.g., centralized unit (CU)-distributed unit (DU), CU-DU) split architecture. In other words, a single gNB may include a single CU and one or more DUs. The CU and the DU are connected through an F1 interface (e.g., a functional split of a third generation partnership project (3GPP) between the CU and the DU). The CU and a core network (e.g., 5GC) are connected through an NG interface. User equipment (UE) accesses the CU through the DU.

In a communication system having a relay function, for example, an integrated access and backhaul (IAB) system, current data transmission is mainly used for a unicast service. In other words, data of a unicast transmission service is sent to only a single terminal device. However, if a multimedia broadcast multicast service (MBMS) is introduced to subsequent 5G communications, and because the MBMS needs to be simultaneously sent to a plurality of terminal devices, transmission of the MBMS cannot be completed using conventional approaches of processing the unicast service in the relay communication system. Therefore, how to transmit the MBMS in the relay communication system is an urgent problem to be resolved.

### SUMMARY

This application provides a data transmission method, an apparatus, and a device, to transmit a multimedia broadcast multicast service (MBMS) in a relay communication system.

According to a first aspect, this application provides a data transmission method. The method may be applied to a first network device. The first network device may be a relay node in a relay communication system, for example, an IAB node in an integrated access/backhaul (IAB) system. The first network device (e.g., an IAB node) receives a first data packet. The first data packet may come from a third network device in the IAB system, for example, an IAB donor or a previous-hop network device of the first network device. The first network device matches first information in the first data packet with second information of the first network device. When the first information matches the second information, the first network device sends the first data packet to user equipment (UE) that accesses the first network device.

In this application, the first data packet is a data packet of a first MBMS, and carries the first information. The first information corresponds to the first MBMS, and may include a routing address of the first MBMS and/or a service identifier of the first MBMS.

Optionally, the second information is configured by the IAB donor for the first network device for the first MBMS, and may include a routing address and/or a service identifier of a second MBMS.

In this application, the first network device matches the second information of the first network device with the first information carried in the first data packet. When the second information is consistent with the first information, the first network device may consider that the first data packet is data that the first network device needs to receive. In this case, the first network device may send the first data packet to the UE that accesses the first network device. In this way, an MBMS is transmitted in the relay communication system.

According to the first aspect, in some possible implementations, when the second information of the first network device matches the first information, the method further includes: The first network device sends the first data packet to N second network devices, where N is a positive integer.

In this application, when the second information of the first network device matches the first information in the first data packet, in addition to sending the first data packet to the UE that accesses the first network device, the first network device further sends the first data packet to the N second network devices. Herein, the N second network devices may be next-hop network devices of the first network device in the relay communication system.

According to the first aspect, in some possible implementations, the method further includes: The first network device obtains N+1 first data packets based on the first data packet. The first network device sends the N+1 first data packets to the terminal device and the N second network devices.

According to the first aspect, in some possible implementations, the method further includes: When the second information of the first network device does not match the first information, the first network device sends the first data packet to N second network devices, where N is a positive integer.

In this application, the second information of the first network device may not match the first information of the first data packet, because the first data packet is the data of the first MBMS. For example, another IAB node may also need to receive multicast data. In these embodiments, in addition to sending the first data packet to the UE that accesses the first network device, the first network device may further send the first data packet to the N second network devices. In this way, an MBMS is transmitted in the IAB system.

According to the first aspect, in some embodiments, that the first network device sends the first data packet to N second network devices includes: The first network device obtains N first data packets based on the first data packet. The first network device sends the N first data packets to the N second network devices.

According to the first aspect, in some possible implementations, when the second information of the first network device does not match the first information, the method further includes: When a next-hop network device of the first network device is unavailable or there is no next-hop network device of the first network device, the first network device discards the first data packet.

According to the first aspect, in some possible implementations, each of the N second network devices are all next-hop network devices of the first network device.

Further, each of the N second network devices may be all available next-hop network devices of the first network device.

According to the first aspect, in some possible implementations, the first information may include the routing address corresponding to the first MBMS and/or the service identifier corresponding to the first MBMS. The second information may include the routing address configured for the first network device and/or the service identifier of the second MBMS.

In this application, the routing address configured for the first network device may correspond to the second MBMS. The second MBMS may be the first MBMS, or may be another MBMS.

According to the first aspect, in some possible implementations, the method further includes: The first network device determines the N second network devices based on the first information. Alternatively, the first information further includes a path identifier (e.g., PATH ID). The method further includes: The first network device determines the N second network devices based on the path identifier.

According to the first aspect, in some possible implementations, the method further includes: The first network device obtains third information, where the third information indicates a mapping relationship between a path identifier and a second network device of the N network devices. That the first network device determines the N second network devices based on the path identifier includes: The first network device determines the N second network devices based on the path identifier and the third information.

According to the first aspect, in some possible implementations, before that the first network device sends the first data packet to the terminal device, the method further includes: The first network device indicates to an internet protocol (IP) layer to not perform first processing on the first data packet, where the first processing includes screening the first data packet based on an IP address carried in the first data packet or discarding the first data packet. Alternatively, the first network device modifies an IP address of the first data packet to a first IP address, where the first IP address is an IP address preconfigured for the first network device.

Herein, a backhaul adaptation protocol (BAP) layer entity (BAP layer) of the first network device indicates to the IP layer not to discard the first data packet, that is, the BAP layer indicates to the IP layer not to screen the first data packet based on the IP address carried in the first data packet or to discard the first data packet. Alternatively, a BAP entity may modify the IP address of the first data packet to the first IP address of the first network device.

According to the first aspect, in some embodiments, that the first network device sends the first data packet to the terminal device includes: The first network device obtains fourth information, where the fourth information includes a multicast IP address configured for the first network device. The first network device sends the first data packet to the terminal device based on the multicast IP address.

According to a second aspect, this application further provides a data transmission method. The method may be applied to a third network device. The third network device may be a donor in a relay communication system, for example, an IAB donor in an IAB system. The method includes: The third network device configures corresponding first information for a first data packet of a first MBMS. The third network device sends the first data packet to a first network device, where the first data packet carries the first information, and the first information triggers the first network device to perform at least one of the following operations: sending the first data packet to a terminal device that accesses the first network device, sending the first data packet to N second network devices, or discarding the first data packet.

According to the second aspect, in some possible implementations, the method further includes: The third network device configures second information for the first network device, where the second information corresponds to a second MBMS.

According to the second aspect, in some possible implementations, the second information includes a routing address configured for the first network device and/or a service identifier of the second MBMS.

According to the second aspect, in some possible implementations, the first information includes a routing address corresponding to the first MBMS and/or a service identifier corresponding to the first MBMS.

According to the second aspect, in some possible implementations, the first information further includes a path identifier corresponding to the first MBMS. The method further includes: The third network device configures third information for the first network device, where the third information indicates a mapping relationship between a path identifier and a second network device.

According to the second aspect, in some possible implementations, the method further includes: The third network device configures fourth information for the first network device, where the fourth information includes a multicast IP address corresponding to the first MBMS, and the multicast IP address indicates the first network device to send the first data packet to the terminal device.

According to a third aspect, this application further provides a data transmission method. The method may be applied to a first network device. The first network device may be a relay node in a relay communication system, for example, an IAB node in an IAB system. The method includes: A first network device receives, in unicast or multicast mode, a second data packet sent by a fourth network device, where the second data packet is a data packet of a third MBMS. The first network device sends, in a unicast or a multicast mode, the second data packet to a second network device and/or a terminal device that accesses the first network device.

According to a third aspect, in some possible implementations, that a first network device receives, in the multicast mode, a second data packet sent by a fourth network device includes: The first network device obtains configuration information corresponding to the second data packet. The first network device receives the second data packet based on the configuration information.

According to a third aspect, in some possible implementations, the configuration information includes at least one of the following: a group radio network temporary identifier (G-RNTI) corresponding to the third MBMS, time domain location information for receiving the second data packet, and frequency domain location information for receiving the second data packet.

According to a fourth aspect, this application provides a communication apparatus. The communication apparatus may be a data transmission apparatus, a chip or a system-on-a-chip in the data transmission apparatus, or a functional module that is in the data transmission apparatus and that is configured to implement the method according to any one of the first aspect or the possible implementations of the first aspect. The communication apparatus may implement a function performed by the first network device in the first aspect, the second aspect, or any possible implementations and combinations of the first aspect and the second aspect. The function may be implemented by hardware that is executing the corresponding software. The hardware or the software includes one or more modules corresponding to the function. For example, the communication apparatus may include: a first receiving module, configured to receive a first data packet, where the first data packet is a data packet of a first MBMS, and where the first data packet carries first information; and a first sending module, configured to: when second information of a first network device matches the first information, send the first data packet to a terminal device that accesses the first network device, where the second information is preconfigured for the first network device.

According to a fourth aspect, in some possible implementations, the first sending module is further configured to: when the second information of the first network device matches the first information, send the first data packet to N second network devices, where N is a positive integer.

According to a fourth aspect, in some possible implementations, the first sending module is further configured to: obtain N+1 first data packets based on the first data packet; and send the N+1 first data packets to the terminal device and the N second network devices.

According to a fourth aspect, in some possible implementations, the apparatus further includes a second sending module, configured to: when second information of the first network device does not match the first information, send the first data packet to N second network devices, where N is a positive integer.

According to a fourth aspect, in some possible implementations, the second sending module is further configured to: obtain N first data packets based on the first data packet; and send the N first data packets to the N second network devices.

According to a fourth aspect, in some possible implementations, the second sending module is further configured to: when the second information of the first network device does not match the first information, and a next-hop network device of the first network device is unavailable, discard the first data packet.

According to a fourth aspect, in some possible implementations, the N second network devices are all next-hop network devices of the first network device.

According to a fourth aspect, in some possible implementations, the first information includes a routing address corresponding to the first MBMS and/or a service identifier corresponding to the first MBMS. The second information includes a routing address configured for the first network device and/or a service identifier of a second MBMS.

According to a fourth aspect, in some possible implementations, the apparatus further includes: a first processing module, configured to determine the N second network devices based on the first information. Alternatively, the first information further includes a path identifier. The first processing module is further configured to determine the N second network devices based on the path identifier.

According to a fourth aspect, in some possible implementations, the first processing module is further configured to: obtain, by the first network device, third information, where the third information indicates a mapping relationship between a path identifier and a second network device; and determine the N second network devices based on the path identifier and the third information.

According to a fourth aspect, in some possible implementations, the first sending module is specifically configured to: before sending the first data packet to the terminal device, indicate to an IP layer not to perform first processing on the first data packet, where the first processing includes screening the first data packet based on an IP address carried in the first data packet or discarding the first data packet; or modify an IP address of the first data packet to a first IP address, where the first IP address is an IP address preconfigured for the first network device.

According to a fourth aspect, in some possible implementations, the first sending module is further configured to: obtain fourth information, where the fourth information includes a multicast IP address configured for the first network device; and send the first data packet to the terminal device based on the multicast IP address.

According to a fifth aspect, this application provides a communication apparatus. The communication apparatus may be a data transmission apparatus, a chip or a system-on-a-chip in the data transmission apparatus, or a functional module that is in the data transmission apparatus and that is configured to implement the method according to any one of the second aspect or the possible implementations of the second aspect. The communication apparatus may implement a function performed by the third network device in the foregoing aspects or the possible implementations. The function may be implemented by hardware executing corresponding software. The hardware or the software includes one or more modules corresponding to the function. For example, the communication apparatus includes: a second processing module configured to configure corresponding first information for a first data packet of a first MBMS; and a third sending module configured to send the first data packet to a first network device, where the first data packet carries the first information, and the first information triggers the first network device to perform at least one of the following operations: sending the first data packet to a terminal device that accesses the first network device, sending the first data packet to N second network devices, or discarding the first data packet.

According to a fifth aspect, in some possible implementations, the second processing module is further configured to configure second information for the first network device, where the second information corresponds to a second MBMS.

According to the fifth aspect, in some possible implementations, the second information includes a routing address configured for the first network device and/or a service identifier of the second MBMS.

According to the fifth aspect, in some possible implementations, the first information includes a routing address corresponding to the first MBMS and/or a service identifier corresponding to the first MBMS.

According to the fifth aspect, in some possible implementations, the first information further includes a path identifier corresponding to the first MBMS. The second processing module is further configured to configure third information for the first network device, where the third information indicates a mapping relationship between a path identifier and a second network device.

According to the fifth aspect, in some possible implementations, the second processing module is further configured to configure fourth information for the first network device, where the fourth information includes a multicast IP address corresponding to the first MBMS, and the multicast IP address indicates the first network device to send the first data packet to the terminal device.

According to a sixth aspect, this application provides a communication apparatus. The communication apparatus may be a data transmission apparatus, a chip or a system-on-a-chip in the data transmission apparatus, or a functional module that is in the data transmission apparatus and that is configured to implement the method according to any one of the third aspect or the possible implementations of the third aspect. The communication apparatus may implement a function performed by the first network device in the third aspect or the other possible implementations. The function may be implemented by hardware executing the corresponding software. The hardware or the software includes one or more modules corresponding to the function. For example, the communication apparatus includes: a second receiving module, configured to receive, in a unicast or a multicast mode, a second data packet sent by a fourth network device, where the second data packet is a data packet of a third MBMS; and a fourth sending module, configured to send, in the unicast or the multicast mode, the second data packet to a second network device and/or a terminal device that accesses the first network device.

According to a sixth aspect, in some possible implementations, the fourth sending module is configured to: obtain configuration information corresponding to the second data packet; and receive the second data packet based on the configuration information.

According to a sixth aspect, in some possible implementations, the configuration information includes at least one of the following: a G-RNTI corresponding to the third MBMS, time domain location information for receiving the second data packet, or frequency domain location information for receiving the second data packet.

According to a seventh aspect, this application provides a network device. The network device includes a processor and a memory. The processor is coupled to the memory. The processor is configured to read and execute instructions in the memory, to implement the data transmission method according to the first aspect, the third aspect, or any possible implementations and/or combinations of the first aspect and the third aspect.

According to an eighth aspect, this application provides a network device. The network device includes a processor and a memory. The processor is coupled to the memory. The processor is configured to read and execute instructions in the memory, to implement the data transmission method according to the second aspect and any possible implementations of the second aspect.

According to a ninth aspect, this application provides a computer-readable storage medium. The computer-readable storage medium stores instructions. When the instructions are run (e.g., executed) on a computer, the instructions are used to perform the data transmission method according to any one of the first aspect to the third aspect.

According to a tenth aspect, this application provides a computer program or a computer program product. When the computer program or the computer program product is executed on a computer, the computer is enabled to implement the data transmission method according to the first aspect, the third aspect, or any feasible combination of the first aspect and the third aspect.

According to an eleventh aspect, this application provides a communication system. The communication system includes an IAB donor, an IAB node, and a UE. The IAB donor is configured to perform the data transmission method according to the second aspect. The IAB node is configured to perform the data transmission method according to the first aspect, the third aspect, or any feasible combination of the first aspect and the third aspect.

Optionally, the communication system may be an IAB system.

It should be understood that, technical solutions in the fourth aspect to the eleventh aspect of this application are consistent with technical solutions in the first aspect to the third aspect of this application. Beneficial effects achieved by these aspects and corresponding feasible implementations are similar. Details are not described again.

### BRIEF DESCRIPTION OF DRAWINGS

To describe technical solutions in embodiments of this application or in the background more clearly, the following describes the accompanying drawings for describing embodiments of this application or the background.

FIG. 1 is a schematic diagram of a structure of a communication system, according to an embodiment of this application;

FIG. 2 is a schematic diagram of a structure of a user-plane protocol stack of a communication system, according to an embodiment of this application;

FIG. 3 is a schematic flowchart of a configuration method, according to an embodiment of this application;

FIG. 4 is a first schematic flowchart of a data transmission method, according to an embodiment of this application;

FIG. 5 is a schematic diagram of a backhaul adaptation protocol (BAP) header format of a unicast service data packet, according to an embodiment of this application;

FIG. 6 is a schematic diagram of a BAP header format of a multicast service data packet, according to an embodiment of this application;

FIG. 7 is a schematic diagram of a BAP header format, according to an embodiment of this application;

FIG. 8 is a second schematic flowchart of a data transmission method, according to an embodiment of this application;

FIG. 9 is a third schematic flowchart of a data transmission method, according to an embodiment of this application;

FIG. 10 is a schematic diagram of a structure of a communication apparatus, according to an embodiment of this application;

FIG. 11 is a second schematic diagram of a structure of a communication apparatus, according to an embodiment of this application; and

FIG. 12 is a third schematic diagram of a structure of a communication device, according to an embodiment of this application.

### DESCRIPTION OF EMBODIMENTS

The following describes embodiments of this application with reference to the accompanying drawings in embodiments of this application. In the following descriptions, reference is made to the accompanying drawings that form a part of this application and show aspects of embodiments of this application in an illustrative manner or in which aspects of embodiments of this application may be used. It should be understood that embodiments of this application may be used in other aspects, and may include structural or logical changes not depicted in the accompanying drawings. For example, it should be understood that disclosed content with reference to the described method may also be applied to a corresponding device or system for performing the method, and vice versa. For example, if one or more method steps are described, a corresponding device may include one or more units (e.g., one or more circuits) such as functional units (e.g., functional circuits) for performing the described one or more method steps (for example, one unit performing the one or more steps, or a plurality of units each performing one or more of the plurality of steps), even if such one or more units are not explicitly described or illustrated in the accompanying drawings. In addition, for example, if an apparatus is described based on one or more units such as functional units, a corresponding method may include a step used to implement functionality of the one or more units (for example, one step used to implement the functionality of the one or more units, or a plurality of steps each used to perform functionality of one or more of a plurality of units), even if such one or more steps are not explicitly described or illustrated in the accompanying drawings. Further, it should be understood that features of various example embodiments and/or aspects described in this specification may be combined with each other, unless otherwise specified.

For ease of understanding of this application, concepts in embodiments of this application are first explained.

Unicast refers to a point-to-point communication technology, namely, a single-point communication method between a network device and a terminal device. The network device may separately send data to each terminal device. Unicast may also be referred to as a unicast transmission mode or a unicast transmission technology.

Sending performed in unicast transmission mode means: When sending a transport block (TB) corresponding to a protocol data unit (PDU), a sending apparatus scrambles, by using a cell radio network temporary identifier (C-RNTI), the PDU or downlink control information (DCI) corresponding to the PDU, and a receiving apparatus receives the same PDU based on the C-RNTI. Alternatively, transmitting a PDU in the unicast mode may mean: The PDU is transmitted through a radio bearer established for unicast transmission or through a channel specially designed for unicast.

Receiving performed in the unicast transmission mode means: When sending is performed in the unicast mode, the receiving apparatus receives the PDU based on the C-RNTI, or the receiving apparatus receives the PDU through the radio bearer established for unicast transmission or through the channel used for unicast transmission.

Multicast refers to a point-to-multipoint communication technology, which may also be referred to as a multicast transmission mode or a multicast transmission technology, and is used for serving a multimedia broadcast multicast service. Multicast may also be referred to as groupcast, and may also be referred to as a broadcast technology in some generalized scenarios. However, multicast is different from a conventional broadcast technology. When the multicast transmission mode is used, a plurality of terminal devices simultaneously receive a same piece of data in a process in which a network device (for example, a base station) sends the data. Currently, multicast transmission technologies are mainly classified into two types: a multimedia broadcast multicast service single frequency network (MBSFN) service and a single-cell point-to-multipoint (SC-PTM) service. In addition, other multicast transmission technologies may also falls within the scope of embodiments of this application. This is not limited.

Sending performed in multicast transmission mode means: When sending a TB corresponding to a PDU, a sending apparatus scrambles, by using a group radio network temporary identifier (G-RNTI), the PDU or DCI corresponding to the PDU, and one or more receiving apparatuses receive the same PDU based on the same G-RNTI. Alternatively, transmitting a PDU in the multicast mode may mean: A plurality of receiving apparatuses are notified of a location of a same PDU in a semi-persistent manner, and the plurality of receiving apparatuses may simultaneously receive the PDU. Alternatively, transmitting a PDU in multicast mode may mean: The PDU is transmitted through a radio bearer established for multicast transmission or through a channel specially designed for multicast.

Receiving performed in multicast transmission mode means: When sending is performed by a peer side in the multicast mode, one of the plurality of receiving apparatuses receives the PDU based on the G-RNTI, or one of the plurality of receiving apparatuses receives the PDU through the radio bearer established for multicast transmission or through the channel used for multicast transmission.

A multimedia broadcast multicast service (MBMS) refers to a point-to-multipoint unidirectional multimedia service. For example, multimedia broadcast services are sent over air interfaces to users in cells through common channels, or user-subscribed multicast services are sent to users in cells in a multicast mode, to save air interface resources.

An embodiment of this application provides a communication system. The communication system may be an IAB system or another communication system having a relay function, for example, a relay system that performs relaying based on a terminal device. Herein, the IAB system is used as an example. The communication system may include a terminal device, an IAB node, and an IAB donor. The terminal device may communicate with the IAB node or the IAB donor, and a communication link between the terminal device and the IAB node is denoted as an access link. In addition, the IAB node may communicate with another IAB node or the IAB donor, and a communication link between the IAB nodes or between the IAB node and the IAB donor is denoted as a backhaul link.

It may be understood that names of these links are merely examples, and do not represent a limitation on the links. When a version of the communication system changes, a corresponding name may alternatively be replaced with a name of a corresponding function in another wireless communication network, and which falls within the protection scope of embodiments of this application.

The terminal device may be a device that provides voice or data connectivity for a user, for example, may also be referred to as user equipment (UE), a mobile station, a subscriber unit, a station (STAtion), or terminal equipment (TE). The terminal device may be a cellular phone, a personal digital assistant (PDA), a wireless modem, a handheld device, a laptop computer, a cordless phone, a wireless local loop (WLL) station, a tablet computer (e.g., a tablet, a pad), or the like. With development of wireless communication technologies, any device that can access a wireless communication system, communicate with a network side of a wireless communication system, or communicate with another device by using a wireless communication system may be the terminal device in embodiments of this application. For example, a terminal and a vehicle in intelligent transportation, a household device in a smart household, an electricity meter reading instrument in a smart grid, a voltage monitoring instrument, an environment monitoring instrument, a video surveillance instrument in an intelligent security network, or a cash register (e.g., a Point-of-Sale terminal). In embodiments of this application, the terminal may communicate with a network device, and a plurality of terminals may also communicate with each other. The terminal may be fixed or movable.

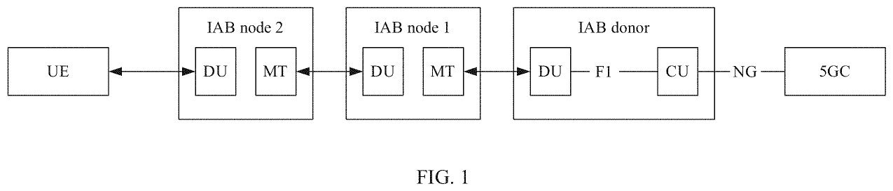

A two-hop data backhaul scenario is used as an example. FIG. 1 is a schematic diagram of a structure of a communication system according to an embodiment of this application. Refer to FIG. 1. The communication system 10 includes a terminal device (for example, a UE) 11, an IAB node 1, an IAB node 2, and an IAB donor.

The UE accesses the IAB node 2 (namely, an access IAB node), and the IAB donor is connected to a core network (for example, a 5GC) through an NG interface. The IAB donor is a previous-hop IAB node of the IAB node 1, the IAB node 1 is a previous-hop IAB node of the IAB node 2, and the IAB node 2 is a previous-hop IAB node of the UE. The IAB node 1 may be divided into two units: a distribution unit (DU) and a mobile terminal (MT). The IAB node 2 may be divided into two units: a DU and an MT. The IAB donor may be divided into two units: a DU and a centralized unit (CU). The IAB node 1 DU communicates with the IAB node 1 MT through an internal interface. The IAB node 2 DU communicates with the IAB node 2 MT through an internal interface. The IAB donor DU communicates with the IAB donor CU through an F1 interface. An interface between the UE and the IAB node 2 (e.g., an interface between the UE and the IAB node 2 DU) is denoted as a Uu interface. An interface between the IAB node 2 and the IAB node 1 (e.g., an interface between the IAB node 2 MT and the IAB node 1 DU) is denoted as a Uu2 interface. An interface between the IAB node 1 and the IAB donor (e.g., an interface between the IAB node 1 MT and the IAB donor DU) is denoted as a Uu1 interface.

In implementations, the IAB system is further used in an N-hop data backhaul scenario, for example, a three-hop data backhaul scenario, a five-hop data backhaul scenario, or an eight-hop data backhaul scenario. Correspondingly, a quantity N of IAB nodes in the IAB system may be an integer greater than or equal to 2, for example, may be 3, 5, or 8. This is not limited to these embodiments of this application.

FIG. 2 is a schematic diagram of a structure of a user-plane protocol stack of a communication system according to an embodiment of this application. Refer to FIG. 2. In comparison with a common base station, a BAP entity (BAP layer) may be newly added to an IAB base station. A main function of the BAP entity is to perform a routing function. In other words, after receiving a data packet, a BAP entity of an MT of an IAB node determines a next destination of the data packet. For example, the BAP entity of the MT transfers the data packet to a higher layer (including but not limited to an IP layer) of the IAB base station for processing, for example, performing IP screening and reading data packet information in an IP header. The higher layer sends, over an air interface, the processed data packet to a UE that accesses the IAB base station (which may be understood as a UE of the IAB base station). Alternatively, the BAP layer of the MT forwards the data packet to a peer BAP layer in a DU in the device for processing, and forwards the processed data packet to a next-hop IAB node, namely, a next IAB base station.

The BAP entity determines a destination of the data packet based on a BAP address and a path identifier (PATH ID) in a header of the data packet. The BAP address and the PATH ID are collectively referred to as a routing identifier(routing ID). Downlink data transmission is used as an example. When each IAB base station is established, an IAB donor base station allocates an address of the IAB base station, namely, a BAP address, to the IAB base station, and specifies, in backhaul routing information, a routing ID corresponding to a next-hop IAB base station of the IAB base station or a routing ID corresponding to the IAB donor base station. Optionally, the routing ID in the backhaul routing information may correspond to an egress link identifier (ID), and the data packet may be sent to the next-hop IAB base station by using the egress link ID.

Before the IAB donor base station sends data, the BAP entity adds a BAP address and a PATH ID to a BAP header. After receiving the data, the IAB base station compares the BAP address in the data with the BAP address allocated to the IAB base station. If the BAP address in the data is the same as the BAP address of the IAB base station, it indicates that the data is sent to the IAB base station. Therefore, the IAB base station delivers the data to an upper layer (for example, an IP layer) for processing, and sends the processed data to the UE of the IAB base station. If the BAP address in the data packet is different from the BAP address of the IAB base station, it indicates that the data is not sent to the IAB base station. In this case, the IAB base station sends the data packet to the next-hop IAB base station or the IAB donor base station based on the BAP address and the PATH ID in the data packet, or discards the data packet. The same rule applies to other IAB base stations.

In embodiments, when the communication system has a relay function, for example, an IAB system, current data transmission is mainly used for a unicast service. In other words, data of a unicast transmission service is sent to only one terminal device. However, if a MBMS is introduced to subsequent 5G communications, because the MBMS needs to be simultaneously sent to a plurality of terminal devices, transmission of the MBMS cannot be completed in conventional approaches for processing the unicast service in the relay communication system. Therefore, how to transmit the MBMS in the relay communication system is an urgent problem to be resolved.

To resolve the foregoing problem, embodiments of this application provide for a data transmission method. The method may be applied to the foregoing communication system. The following describes the data transmission method in detail with reference to the IAB system in the foregoing two-hop backhaul scenario.

First, it should be noted that: A first network device may be the 1^{st} relay node, for example, the IAB node 1, connected to the IAB donor in the IAB system; may be another relay node (for example, an IAB node i, where i is a positive integer greater than 1) in the IAB system; or may be an IAB node n, namely, an edge node, connected to the UE in the IAB system. A second network device may be a next-hop network device of the first network device in the IAB system, where for example, the first network device is the IAB node 1, and the second network device is the IAB node 2; or may be another relay node, for example, a next-hop node of the IAB node i, in the IAB system. This is not specifically limited. In these embodiments of this application, an example in which the first network device is the IAB node 1, and the second network device is the IAB node 2 is used. A third network device may be the IAB donor in the IAB system.

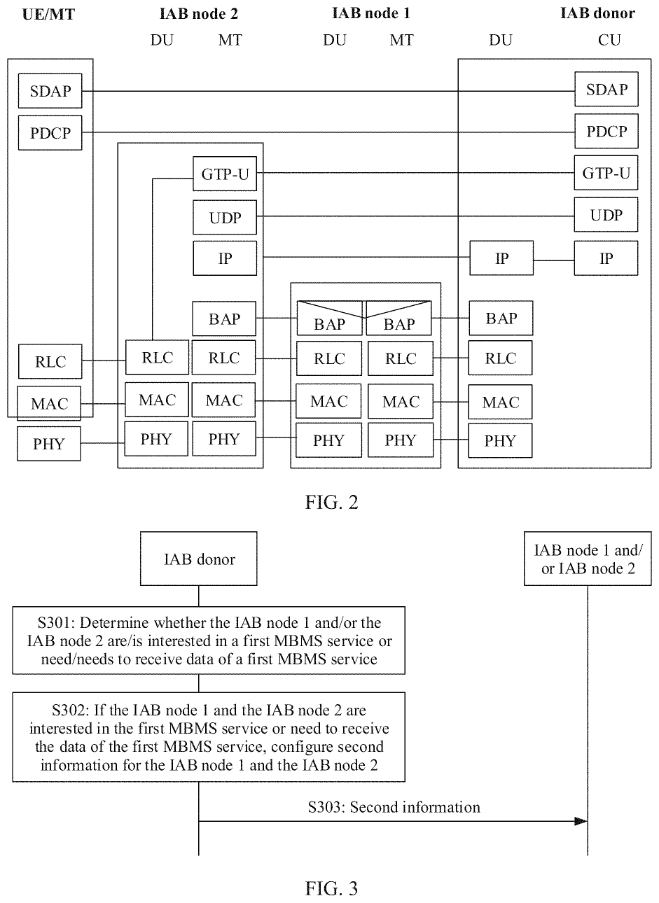

FIG. 3 is a schematic flowchart of a configuration method according to an embodiment of this application. Refer to FIG. 3. The method may include the following steps.

S301: An IAB donor determines whether an IAB node 1 and/or an IAB node 2 are/is interested in a first MBMS or need/needs to receive data of a first MBMS.

Herein, the MBMS is a service oriented to a plurality of UEs, for example, a live broadcast service, a part of a public safety service, or a batch software update service.

In some embodiments, if an IAB node is interested in the first MBMS or needs to receive the data of the first MBMS, the IAB node may actively report first service information to an IAB donor CU, to notify the IAB donor CU that the IAB node is interested in the first MBMS or needs to receive the data of the first MBMS. Certainly, when sending the first service information, the IAB node may alternatively notify the IAB donor CU that the IAB node is interested in another MBMS or needs to receive data of another MBMS. In other words, the IAB node may report preference of the IAB node for MBMS to the IAB donor CU at a time, or may report preference for one MBMS to the IAB donor CU each time. This is not limited to these embodiments.

It should be noted that, in embodiments, that the IAB node reports information to the IAB donor herein may be that a terminal device that accesses the IAB node reports information to the IAB donor, and the reported information is sent to the IAB donor through the IAB node. That the IAB node is interested in the first MBMS or needs to receive the data of the first MBMS may be that the terminal device that accesses the IAB node is interested in the first MBMS or needs to receive the data of the first MBMS. That is, the reporting process may be initiated by the IAB node or a UE that accesses the IAB node.

In embodiments, the IAB donor CU may alternatively deliver a report request (for example, by using a counting mechanism) to the IAB node, to request the IAB node to report the first service information. After receiving the report request, the IAB node reports the first service information to the IAB donor. As described above, herein, the IAB donor CU may alternatively deliver the report request to the UE that accesses the IAB node.

Therefore, after receiving a service indication reported by the IAB node, the IAB donor may determine that the IAB node or the UE that accesses the IAB node is interested in the first MBMS or needs to receive the data of the first MBMS.

In some possible implementations, when establishing or modifying a PDU session or a quality of service (QoS) flow, a core network device may send second service information to the IAB donor CU, to notify the IAB donor CU that the PDU session or the QoS flow is used to transmit an MBMS. In this case, the IAB donor CU may determine that an IAB node or a UE corresponding to the PDU session or the QoS flow is interested in the MBMS or needs to receive data of the MBMS. For an uplink service, the core network device may receive a service establishment request of the UE, to determine that the UE needs to receive the MBMS. For a downlink service, the core network device may determine whether the downlink service is the MBMS, and determine, based on address information of the UE or a UE ID, UEs to which the MBMS is sent.

Further, the second service information delivered by the core network device may indicate a specific MBMS transmitted by using the PDU session or the QoS flow. For example, the PDU session or the QoS flow is used to transmit the first MBMS.

According to the foregoing method, the IAB donor may determine whether the IAB node 1 and the IAB node 2 or the UEs that access the IAB node 1 and the IAB node 2 are interested in the first MBMS or need to receive the data of the first MBMS.

S302: If the IAB node 1 and the IAB node 2 or the UEs that access the IAB node 1 and the IAB node 2 are interested in the first MBMS or need to receive the data of the first MBMS, the IAB donor configures second information for the IAB node 1 and the IAB node 2.

Herein, the second information may include a routing address and/or a service identifier of a second MBMS. The routing address may include a BAP address allocated by the IAB donor to the IAB node or a first address that is allocated by the IAB donor to the IAB node and that indicates the IAB node. This is not specifically limited.

In some possible embodiments, the routing address may correspond to the first MBMS. In other words, for different MBMS, the IAB donor may configure different routing addresses for the MBMS based on requirements of the IAB node for the MBMS, so that the IAB node can use different processing policies for data packets of the different MBMS. Alternatively, the routing address may not be associated with the first MBMS, and is merely an address configured by the IAB donor to indicate the IAB node. The data of the first MBMS can be sent to the IAB node based on the routing address. This is not specifically limited.

In embodiments, the IAB node or the UE that accesses the IAB node may report indications of interest in a plurality of MBMS. Therefore, the IAB donor may configure a plurality of routing addresses for the IAB node, where the plurality of routing addresses correspond to different MBMS; or the IAB donor may configure one routing address for the IAB node, where the routing address corresponds to the plurality of MBMS.

S303: The IAB donor sends the second information to a corresponding IAB node.

After configuring the corresponding second information for the IAB node in S301 and S302, the IAB donor sends the second information to the corresponding IAB node by using an F1 interface control signaling or radio resource control (RRC) signaling.

In this way, the IAB donor completes the process of configuring the IAB node.

In the foregoing configuration process, the IAB donor CU configures the IAB node, and sends the configured second information to the IAB node.

Next, the foregoing IAB system performs data transmission. The following data transmission system uses downlink transmission as an example for description. A process of uplink transmission is similar to that of downlink transmission.

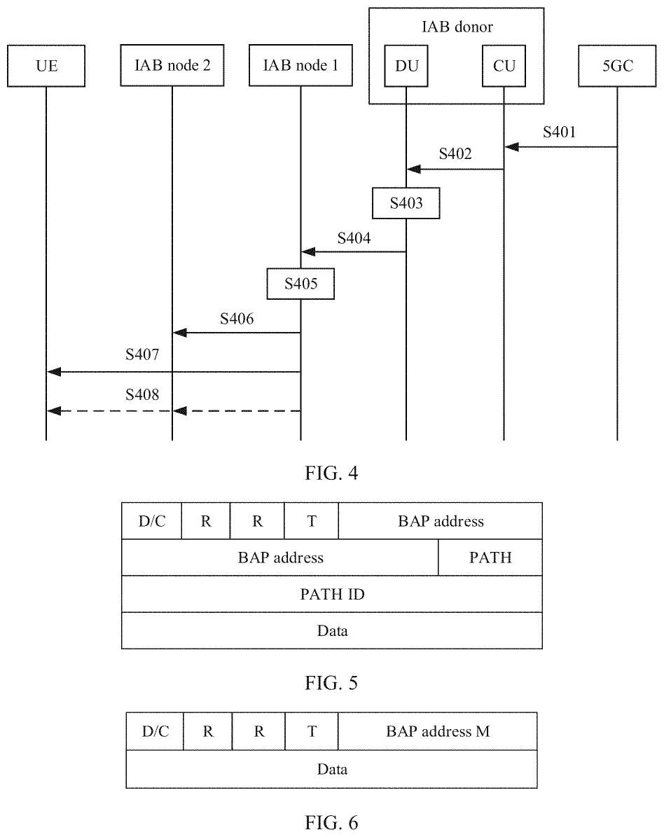

FIG. 4 is a first schematic flowchart of a data transmission method according to an embodiment of this application. Refer to a solid line in FIG. 4. The method may include the following steps.

S401: An IAB donor CU receives a first data packet from a core network.

The first data packet is a data packet of a first MBMS.

In embodiments, the core network configures corresponding indication information for each MBMS. The indication information may include at least one of the following: an internet protocol version 6 (IPv6) flow label, a differentiated services code point ( ) identifier, a destination IP address, and a service identifier of the MBMS. Certainly, the indication information may alternatively include other information. This is not specifically limited. The indication information may be included in a data packet or carried in separate control signaling.

Further, the destination IP address may be a multicast IP address, namely, a same IP address allocated to a plurality of IAB nodes. The multicast IP address may be used to send and receive the MBMS.

S402: The IAB donor CU sends the first data packet to an IAB donor DU.

Herein, when the IAB donor CU performs S402, the indication information may be carried in a header of the first data packet, and sent to the IAB donor DU. Certainly, the indication information may alternatively be sent by the IAB donor CU to the IAB donor DU by using independent control signaling, for example, a FI interface signaling. Certainly, the indication information may alternatively be sent in another manner. This is not specifically limited to these embodiments.

S403: The IAB donor DU configures first information for the first data packet.

In some possible implementations, the IAB donor CU may send, to the IAB donor DU in advance, a mapping relationship between indication information corresponding to different MBMS and routing information. In other words, the IAB donor CU allocates fifth information to the different MBMS, where the fifth information may include a routing address (for example, a BAP address or a first address) and/or a service identifier of an MBMS, and the first address is an address that is allocated by the IAB donor CU to an IAB node 1 and that indicates only the IAB node 1.

In this case, after receiving the first data packet, the IAB donor DU may determine the first information based on the first data packet or first indication information corresponding to the first MBMS (where the first indication information is indication information corresponding to the first MBMS) and the mapping relationship, and add the first information to the header (for example, a BAP header) of the first data packet. In other words, the IAB donor DU performs a query based on the mapping relationship, to find the first information corresponding to the first indication information, and then adds the first information to the header of the first data packet.

In some possible implementations, the first information may include a routing address (for example, a BAP address or a second address) of the first MBMS and/or a service identifier of the first MBMS.

S404: The IAB donor DU sends the first data packet that carries the first information to the IAB node 1.

The IAB donor CU may configure a mapping relationship between routing information and a next-hop IAB node for the IAB donor DU. The mapping relationship is used by the IAB donor DU to determine the next-hop IAB node. After determining the first information, the IAB donor DU may determine the next-hop IAB node based on the first information and the mapping relationship. The next-hop IAB node continues to search for a next-hop IAB node based on the routing information configured by the IAB donor CU. The same rule applies to other next-hop IAB nodes. After passing through several IAB nodes, the first data packet carrying the first information arrives at the IAB node 1.

S405: The IAB node 1 determines whether the first information carried in the first data packet matches second information of the IAB node 1. If the first information matches the second information, the IAB node 1 performs step S406; or if the first information does not match the second information, the IAB node 1 performs step S407.

The IAB node 1 compares the first information in the first data packet with the second information of the IAB node 1, and determines whether the first information matches the second information. For example, the IAB node 1 compares the BAP address in the first data packet with a BAP address configured by the IAB donor for the IAB node 1, to determine whether the two BAP addresses match. This may be understood as determining whether the BAP address in the first data packet is consistent with the BAP address configured by the IAB donor for the IAB node 1. If the two BAP addresses match (e.g., are consistent), the IAB node 1 performs step S406; or if the two BAP addresses do not match (e.g., are not consistent), the IAB node 1 performs step S407. Alternatively, the IAB node 1 may compare the service identifier of the first MBMS in the first data packet with a service identifier of a second MBMS configured by the IAB donor for the IAB node 1, to determine whether the two service identifiers match. If the two service identifiers match, the IAB node 1 performs step S406; or if the two service identifiers do not match, the IAB node 1 performs step S407.

S406: The IAB node 1 sends the first data packet to at least one UE that accesses the IAB node 1.

In S401 to S407, steps performed by the IAB node 1 may be performed by a BAP entity (e.g., the BAP layer) in the IAB node 1. In this case, in S406, the BAP entity of the IAB node 1 removes the BAP header of the first data packet, and transmits the first data packet to a higher layer of the IAB node 1, for example, an IP layer, for further processing, for example, performing IP screening and reading data packet information in an IP header. Then, the higher layer sends, in a unicast or a multicast mode, the first data packet to the UE that accesses the IAB node 1.

In some possible implementations, because a data packet of a same MBMS is sent to a plurality of IAB nodes, an IP address in the data packet may not match an IP address of a part of the IAB nodes. In this case, the data packet is likely to be discarded at the IP layer. To prevent the data packet from being discarded by the IAB node, when performing step S406, the BAP entity may indicate to the IP layer to not perform first processing on the first data packet, so that the IP layer ignores a difference between the IP addresses. Therefore, the IAB node can send the first data packet to the UE, instead of discarding the first data packet due to a mismatch of the IP addresses.

In embodiments, the first processing may include screening the first data packet based on the IP address carried in the first data packet or discarding the first data packet. In other words, the BAP entity may send second indication information to the IP layer, where the second indication information may indicate to the IP layer to not perform IP address screening on the first data packet or to not discard the first data packet.

Certainly, in other embodiments of this application, in the foregoing configuration process, the IAB donor may alternatively configure at least one IP address for the IAB node. In this case, when step S406 is performed, if the IP address of the first data packet does not match the at least one IP address, the IAB node may modify the IP address of the first data packet to a first IP address in the at least one IP address. In this way, when the IP layer performs the processing, and because the IP addresses match, the IP layer does not discard the first data packet.

In embodiments, the BAP entity may alternatively use another manner to prevent the first data packet from being discarded by the IAB node 1. This is not specifically limited.

In embodiments of the foregoing configuration process, the IAB donor may alternatively configure, for the IAB node 1, one or more multicast IP addresses (e.g., fourth information) corresponding to the MBMS. In this case, the BAP entity of the IAB node 1 may send the first data packet to the IP layer. The IP layer screens a destination IP address (e.g., one or more multicast IP addresses) carried in the first data packet and the one or more multicast IP addresses configured for the IAB node 1. If there are matched multicast IP addresses that exist, the IP layer considers that the first data packet is a data packet that the IP layer needs to receive, and sends the first data packet to the UE; or if there are no matched multicast IP addresses that exist, the IP layer considers that the first data packet is not a data packet that the IP layer needs to receive, and may discard the first data packet.

S407: The IAB node 1 sends the first data packet to N next-hop IAB nodes (namely, IAB nodes 2).

Herein, after determining, in S405, that the first information does not match the second information, the IAB node 1 may determine that the first data packet is not a data packet sent to the IAB node 1 or to the UE that accesses the IAB node 1. In this case, the IAB node 1 forwards the first data packet to the next-hop IAB nodes, instead of sending the first data packet to the UE that accesses the IAB node 1.

The IAB node 1 may be connected to the N IAB nodes 2, where N is a positive integer. In this case, after determining that the first data packet is not the data packet sent to the IAB node 1, the IAB node 1 forwards the first data packet to the next-hop IAB nodes. In this case, the IAB node 1 needs to first determine the next-hop IAB nodes. Because the IAB system is an IAB system in a two-hop backhaul scenario, the N IAB nodes 2 are all next-hop IAB nodes of the IAB node 1, and the IAB node 1 sends the first data packet to the N IAB nodes 2.

Further, to ensure effective data transmission, when determining the next-hop IAB nodes, the IAB node 1 may select N available IAB nodes in all the next-hop IAB nodes of the IAB node 1. For example, the IAB node 1 is connected to M IAB nodes 2, where M is a positive integer greater than N. The IAB node 1 may determine N available IAB nodes 2 in the M IAB nodes 2 as the next-hop IAB nodes. On the contrary, if all the next-hop IAB nodes of the IAB node 1 are unavailable, the IAB node 1 discards the first data packet.

It should be noted that “available” means reachable. In other words, if an IAB node is available, it indicates that the IAB node can complete normal transmission. On the contrary, if an IAB node is unavailable, it indicates that the IAB node may fail to meet a transmission requirement due to reasons such as poor radio link quality, a radio link disconnection, or a radio link failure.

In embodiments, after determining, in 5405, that the first information does not match the second information, the IAB node 1 may further determine whether there is a next-hop IAB node of the IAB node 1. If there is no next-hop IAB node of the IAB node 1, the IAB node 1 may be an edge node or a last node in the IAB system. In this case, the IAB node 1 may discard the first data packet.

In some embodiments, 5407 may further include: The IAB node 1 determines the N next-hop IAB nodes (e.g., IAB nodes 2) based on the first information.

After determining to forward the first data packet to the next-hop IAB nodes, the IAB node 1 may further determine, as the next-hop IAB nodes based on the first information (for example, the BAP address) in the first data packet, N IAB nodes 2 that match the BAP address and that are in the IAB nodes 2 connected to the IAB node 1, and send the first data packet to the N IAB nodes 2.

Further, the first information may include a PATH ID. In this case, the IAB node 1 further determines the next-hop IAB nodes based on the PATH ID. The IAB node 1 may determine, as the next-hop IAB nodes, N IAB nodes 2 that match both the BAP address and the PATH ID in the first data packet and that are in the IAB nodes 2 connected to the IAB node 1, and send the first data packet to the N IAB nodes 2.

It should be noted that data packets in the foregoing communication system may be classified into two types: a unicast service data packet and a multicast service data packet, and the two types of service data packets use different data packet formats.

FIG. 5 is a schematic diagram of a BAP header format of a unicast service data packet according to an embodiment of this application. Refer to FIG. 5. R (e.g., reserved) is a reserved field. Because a format of the unicast service data packet is different from a format of the multicast service data packet, a T field (which may be referred to as a Type field) indicates whether the data packet is the unicast service data packet or the multicast service data packet. A BAP address field may also be referred to as a DESTINATION field, and indicates a BAP address corresponding to the data packet. A Data field is a payload (for example, an IP packet) corresponding to the data packet. A D/C field indicates whether the data packet is a control PDU or a data PDU. A PATH ID field may also be referred to as a PATH field, and indicates a PATH ID. FIG. 6 is a schematic diagram of a BAP header format of a multicast service data packet according to an embodiment of this application. Refer to FIG. 6. Differently than a unicast service, when the data packet is the multicast service data packet, a BAP address field indicates a BAP address corresponding to a multicast service, and may be referred to as a BAP address M.

In embodiments, through implementation of step 5407, complexity of the entire configuration process and processing complexity of each IAB base station are reduced, a header format of an MBMS data packet is simplified, and transmission overhead is reduced.

In some possible implementations, the IAB node 1 may further obtain third information, where the third information indicates a mapping relationship between a PATH ID and a next-hop IAB node. Further, the second information and the third information may jointly indicate a mapping relationship between a routing address and a PATH ID and a next-hop IAB node. In actual application, the third information may be configured by the IAB donor for the IAB node 1 in the foregoing configuration process, or may be preset or created by the IAB node. The IAB node 1 queries, based on the third information, N IAB nodes 2 that match both the routing address and at least one of PATH IDs in the first data packet, namely, the next-hop IAB nodes, and sends the first data packet to the N IAB nodes 2.

In embodiments, the third information may include a routing address (for example, a BAP address) corresponding to an MBMS, a PATH ID, and a routing address (for example, a BAP address) and a PATH ID of a next-hop IAB node. Alternatively, the third information may include a link identifier. The link identifier is an identifier of an egress link corresponding to a next-hop IAB node. The link identifier may be configured by the IAB donor for the IAB node 1, or may be created by the IAB node 1 based on a routing address (for example, a BAP address) corresponding to a MBMS, a PATH ID, a routing address (for example, a BAP address) and a PATH ID of a next-hop IAB node, and the like that are configured by the IAB donor for the IAB node 1. Certainly, the link identifier may alternatively be obtained in another manner. This is not specifically limited.

It should be noted that, when the IAB donor configures the third information for the IAB node 1, data packets in the foregoing communication system may be classified into two types: a unicast service data packet and a multicast service data packet, and the two types of service data packets share a same data packet format. BAP headers of different multicast service data packets carry BAP addresses and/or PATH IDs corresponding to multicast services, and BAP headers of different unicast service data packets carry BAP addresses and/or PATH IDs corresponding to destination IAB nodes.

The BAP addresses corresponding to the IAB nodes are different on the IAB nodes, and each BAP address may correspond to a plurality of unicast services. A BAP address corresponding to a multicast service may be simultaneously configured for a plurality of different IAB nodes, and each BAP address corresponds to one or more multicast services.

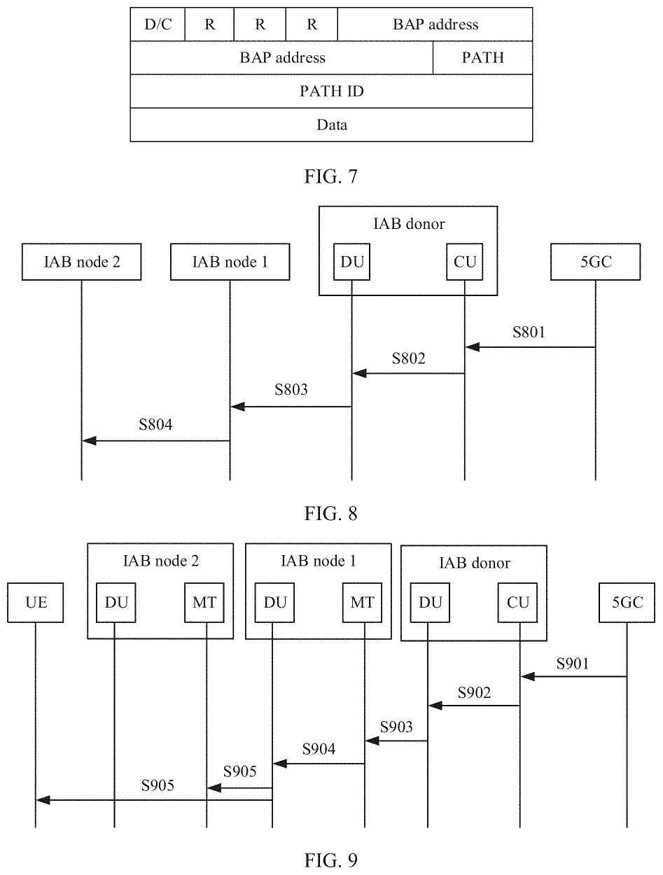

FIG. 7 is a schematic diagram of a BAP header format according to an embodiment of this application. Refer to FIG. 7. R is a reserved field. A BAP address field may also be referred to as a DESTINATION field, and indicates a BAP address corresponding to the data packet. A Data field is a payload (for example, an IP packet) corresponding to the data packet. A D/C field indicates whether the data packet is a control PDU or a data PDU. A PATH ID field may also be referred to as a PATH field, and indicates a PATH ID.

In embodiments, because the IAB donor configures, for the IAB node 1, a public routing address (for example, the second information and the third information) corresponding to the MBMS, an MBMS data packet can be prevented from being transmitted along a redundant path, so that the entire transmission process is simplified and efficient.

In this case, in 5407, when searching for a next-hop IAB node, the IAB node 1 may further first query, based on the third information, whether there are N IAB nodes 2 (namely, next-hop IAB nodes) that match the routing address and at least one of PATH IDs. If there are N IAB nodes 2 that match the routing address and the at least one PATH ID, the IAB node 1 sends the first data packet to the N IAB nodes 2; or if there are no IAB node 2 that matches the routing address and the at least one PATH ID, the IAB node 1 queries whether there are N IAB nodes 2 that match the routing address. If there are N IAB nodes 2 that match the routing address, the IAB node 1 sends the first data packet to the N IAB nodes 2; or if there is neither an IAB node 2 that matches the routing address nor an IAB node 2 that matches the at least one PATH ID, the IAB node 1 may discard the first data packet or send the first data packet to all IAB nodes 2 connected to the IAB node 1, namely, all next-hop IAB nodes of the IAB node 1.

It should be noted that before sending the first data packet to the N IAB nodes 2, the IAB node 1 may further replicate the first data packet, to obtain N first data packets including the original first data packet (namely, the first data packet from the IAB donor). The N first data packets are the same as the original first data packet. Then, the IAB node 1 sends the N first data packets to the N IAB nodes 2. Certainly, the IAB node 1 may alternatively send the first data packet from the IAB donor to the N IAB nodes 2 through N times of sending.

In this way, the downlink MBMS is transmitted in the IAB system.

Refer to a dashed line in FIG. 4. In embodiments, after determining, in S405, that the first information in the first data packet matches the second information of the IAB node 1, the IAB node 1 may further perform S408: The IAB node 1 sends the first data packet to at least one UE that accesses the IAB node 1 and the N IAB nodes 2.

It should be noted that the N IAB nodes 2 herein are consistent with the N IAB nodes 2 in the foregoing embodiment. Details are not described herein again.

When determining that the first information in the first data packet matches the second information of the IAB node 1, the IAB node 1 may send the first data packet to the N IAB nodes 2 and the UE that accesses the IAB node 1. Specifically, the IAB node 1 may replicate the first data packet, to obtain N+1 first data packets including the original first data packet (namely, the first data packet from the IAB donor). The N+1 first data packets are the same as the original first data packet. Then, the IAB node 1 sends one of the N+1 first data packets to the UE, and sends the other N first data packets to the N IAB nodes 2. Certainly, the IAB node 1 may alternatively send the first data packet from the IAB donor to the UE and the N IAB nodes 2 through N+1 times of sending.

In another embodiment of this application, FIG. 8 is a second schematic flowchart of a data transmission method according to an embodiment of this application. Refer to FIG. 8. The method may include the following steps.

S801: An IAB donor CU receives a first data packet from a core network.

S802: The IAB donor CU sends the first data packet to an IAB donor DU.

S803: The IAB donor DU sends the first data packet to an IAB node 1.

S804: The IAB node 1 sends the first data packet to N next-hop IAB nodes (namely, IAB nodes 2).

In S801 to S804, the IAB donor CU does not need to configure first information for the first data packet, but may directly send the first data packet to the IAB node 1, and the IAB node 1 forwards the first data packet to the N IAB nodes 2. In other words, the IAB node 1 does not need to match the first information in the first data packet with second information of the IAB node 1, but directly forwards the first data packet to the N IAB nodes 2.

In the embodiments shown in FIG. 4 and FIG. 8, the IAB donor does not need to additionally configure a BAP address for an MBMS. In addition, the MBMS is transmitted over an access link. This can reduce a load of a backhaul link.

An embodiment of this application further provides a data transmission method. The method may be applied to the foregoing IAB system.

FIG. 9 is a third schematic flowchart of a data transmission method according to an embodiment of this application. Refer to FIG. 9. The method may include the following steps.

S901: An IAB donor CU receives a second data packet from a core network.

Herein, the second data packet is a data packet of a third MBMS, and may be the same as or different from a first data packet.

S902: The IAB donor CU sends the second data packet to an IAB donor DU.

S903: The IAB donor DU sends the second data packet to an IAB node 1 MT in a unicast or a multicast mode.

S904: The IAB node 1 MT sends the first data packet to the IAB node 1 DU.

S905: The IAB node 1 DU sends the second data packet to a UE and/or an IAB node 2 MT in the unicast or the multicast mode.

S901 to S905 may be: An IAB donor or a previous-hop IAB node sends, in the unicast or the multicast mode, the second data packet of the third MBMS to at least one UE that accesses the IAB donor or the previous-hop IAB node and a first-level IAB node (for example, the IAB node 1). After receiving the second data packet, the first-level IAB node may further send, in the unicast or the multicast mode, at least one UE that accesses the first-level IAB node and a second-level IAB base station (for example, the IAB node 2).

After an IAB node receives the second data packet from a previous-level IAB node in the unicast or the multicast mode, the second data packet may be processed by a physical (PHY) layer and a media access control (MAC) layer in an IAB node MT, processed by a MAC layer and a PHY layer in an IAB node DU, and then sent out. Alternatively, the second data packet may be processed by a PHY layer, a MAC layer, and a radio link control (RLC) layer in an IAB node MT, processed by an RLC layer, a MAC layer, and a PHY layer in the IAB node DU, and then sent out. Certainly, the second data packet may alternatively be processed by packet data convergence protocol (PDCP) layers in the two modules, and then sent out. The same rule applies to other IAB nodes. Details are not described again.

In embodiments, sending performed in the multicast transmission mode in step S905 means: When sending a TB corresponding to a PDU session, the IAB donor CU or the previous-hop IAB node DU scrambles, by using a G-RNTI, the PDU or DCI corresponding to the PDU. Further, one or more IAB node MTs or UEs may receive the same PDU based on the same G-RNTI. Alternatively, the IAB donor CU or the IAB node DU notifies a plurality of IAB node MTs of a time domain or frequency domain location of a same PDU in a semi-persistent manner, and the plurality of IAB node MTs or UEs may simultaneously receive the PDU. Alternatively, the IAB donor CU or the IAB node DU transmits the PDU through a radio bearer established for multicast transmission or through a channel (for example, a multicase control channel (MCCH)/multicast traffic channel (MTCH)) designed for multicast.

Correspondingly, receiving performed in multicast mode in step S903 means: When the IAB donor CU or the previous-hop IAB node DU performs sending in the multicast mode, one of the plurality of IAB node MTs or UEs receives the PDU based on G-RNTI, or one of the plurality of IAB node MTs or UEs receives the PDU through the radio bearer established for multicast transmission or through the channel used for multicast transmission.

In some possible implementations, if the IAB node needs to receive the data packet of the MBMS from the previous-level IAB node in multicast mode, the IAB donor needs to send, to the IAB node, configuration information that is used to receive multicast sent by the upper-level IAB node. In embodiments, the configuration information may include information such as a G-RNTI corresponding to the third MBMS, time domain location information for receiving the second data packet, and frequency domain location information for receiving the second data packet, or may include information such as a physical channel, a transmission channel, and a logical channel for receiving the third MBMS. This is not specifically limited to these embodiments.

In embodiments, the configuration information may be sent by the IAB donor to the IAB node by using F1 interface control signaling or RRC signaling.

In a possible implementation, the IAB node may further receive the second data packet from the previous-level IAB node in the unicast mode, and then send the second data packet to a next-level IAB node in the multicast mode. Alternatively, the IAB node may receive the second data packet from the previous-level IAB node in the multicast mode, and then send the second data packet to a next-level IAB node in the unicast mode. This is not specifically limited to these embodiments.

In some possible implementations, in the embodiments shown in FIG. 4 to FIG. 8, the data packet of the MBMS is sent over the backhaul link. In essence, in the embodiment shown in FIG. 9, the data packet of the MBMS is sent over the access link. The two sending manners may be performed independently, that is, either of the two sending manners is selected, or the IAB donor may indicate a manner in which the IAB node transmits the data packet of the MBMS.

In the embodiment shown in FIG. 9 of this application, the IAB donor does not need to additionally configure a BAP address for an MBMS. In addition, the MBMS is transmitted over the access link. This can reduce load of the backhaul link.

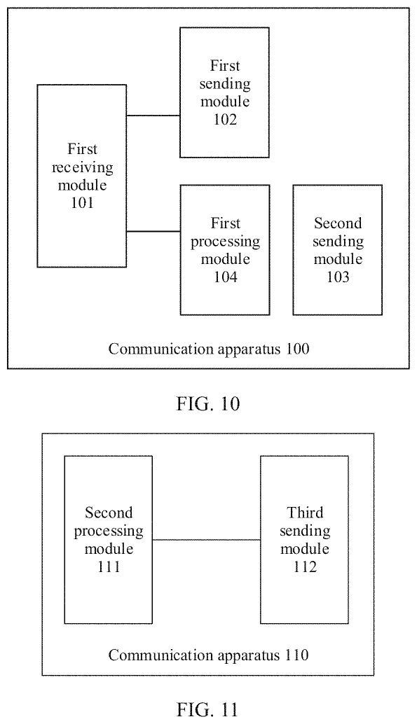

Based on a same concept, an embodiment of this application provides a communication apparatus. The communication apparatus may be a data transmission apparatus, a chip or a system-on-a-chip in the data transmission apparatus, or a functional module that is in the data transmission apparatus and that is configured to implement the method performed by the IAB node 1 in the foregoing embodiment. The function may be implemented by hardware executing a corresponding software. The hardware or the software includes one or more modules corresponding to the function. For example, FIG. 10 is a first schematic diagram of a structure of a communication apparatus according to an embodiment of this application. Refer to FIG. 10. The communication apparatus 100 may include: a first receiving module 101, configured to receive a first data packet, where the first data packet is a data packet of a first MBMS, and the first data packet carries first information; and a first sending module 102, configured to: if second information of a first network device matches the first information, send the first data packet to a terminal device that accesses the first network device, where the second information is preconfigured for the first network device.

In some possible implementations, the first sending module is further configured to: if the second information of the first network device matches the first information, send the first data packet to N second network devices, where N is a positive integer.

In some possible implementations, the first sending module is further configured to: obtain N+1 first data packets based on the first data packet; and send the N+1 first data packets to the terminal device and the N second network devices, where N is a positive integer.

Still referring to FIG. 10. In some possible implementations, the apparatus further includes a second sending module 103, configured to: if second information of the first network device does not match the first information, send the first data packet to N second network devices, where N is a positive integer.

In some possible implementations, the second sending module is further configured to: obtain N first data packets based on the first data packet; and send the N first data packets to the N second network devices.

In some possible implementations, the second sending module is further configured to: if the second information of the first network device does not match the first information, and a next-hop network device of the first network device is unavailable, discard the first data packet.

In some possible implementations, the N second network devices are all next-hop network devices of the first network device.

In some possible implementations, the first information includes a routing address corresponding to the first MBMS and/or a service identifier corresponding to the first MBMS. The second information includes a routing address configured for the first network device and/or a service identifier of a second MBMS.

Still referring to FIG. 10. In some possible implementations, the apparatus further includes: a first processing module 104, configured to determine the N second network devices based on the first information. Alternatively, the first information further includes a path identifier. The first processing module is further configured to determine the N second network devices based on the path identifier.

In some possible implementations, the first processing module is further configured to: obtain, by the first network device, third information, where the third information indicates a mapping relationship between a path identifier and a second network device; and determine the N second network devices based on the path identifier and the third information.

In some possible implementations, the first sending module is configured to: before sending the first data packet to the terminal device, indicate to an IP layer not to perform first processing on the first data packet, where the first processing includes screening the first data packet based on an IP address carried in the first data packet or discarding the first data packet; or modify an IP address of the first data packet to a first IP address, where the first IP address is an IP address preconfigured for the first network device.

In some possible implementations, the first sending module is further configured to: obtain fourth information, where the fourth information includes a multicast IP address configured for the first network device; and send the first data packet to the terminal device based on the multicast IP address.

Based on a same concept, an embodiment of this application provides a communication apparatus. The communication apparatus may be a data transmission apparatus, a chip or a system-on-a-chip in the data transmission apparatus, or a functional module that is in the data transmission apparatus and that is configured to implement the method performed by the IAB donor in the foregoing embodiments. The function may be implemented by hardware executing corresponding to software. The hardware or the software includes one or more modules corresponding to the function. For example, FIG. 11 is a second schematic diagram of a structure of a communication apparatus according to an embodiment of this application. Refer to FIG. 11. The communication apparatus 110 includes: a second processing module 111, configured to configure corresponding first information for a first data packet of a first MBMS; and a third sending module 112, configured to send the first data packet to a first network device, where the first data packet carries the first information, and the first information triggers the first network device to perform at least one of the following operations: sending the first data packet to a terminal device that accesses the first network device, sending the first data packet to N second network devices, and discarding the first data packet.

In some possible implementations, the second processing module is further configured to configure second information for the first network device, where the second information corresponds to a second MBMS.

In some possible implementations, the second information includes a routing address configured for the first network device and/or a service identifier of the second MBMS.

In some possible implementations, the first information includes a routing address corresponding to the first MBMS and/or a service identifier corresponding to the first MBMS.

In some possible implementations, the first information further includes a path identifier corresponding to the first MBMS. The second processing module is further configured to configure third information for the first network device, where the third information indicates a mapping relationship between a path identifier and a second network device.

In some possible implementations, the second processing module is further configured to configure fourth information for the first network device, where the fourth information includes a multicast IP address corresponding to the first MBMS, and the multicast IP address indicates to the first network device to send the first data packet to the terminal device.

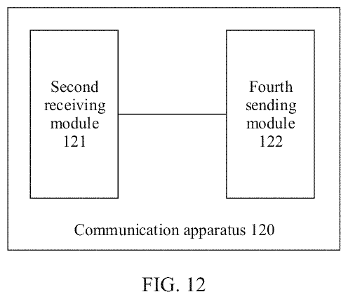

Based on a same concept, an embodiment of this application provides a communication apparatus. The communication apparatus may be a data transmission apparatus, a chip or a system-on-a-chip in the data transmission apparatus, or a functional module that is in the data transmission apparatus and that is configured to implement the method performed by the IAB node 1 in the foregoing embodiments. The function may be implemented by hardware executing corresponding to software. The hardware or the software includes one or more modules corresponding to the function. For example, FIG. 12 is a third schematic diagram of a structure of a communication device according to an embodiment of this application. Refer to FIG. 12. The communication apparatus 120 includes: a second receiving module 121, configured to receive, in a unicast or a multicast mode, a second data packet sent by a fourth network device, where the second data packet is a data packet of a third multimedia broadcast multicast service MBMS; and a fourth sending module 122, configured to send, in the unicast or the multicast mode, the second data packet to a second network device and/or a terminal device that accesses the first network device.

In some possible implementations, the fourth sending module is configured to: obtain configuration information corresponding to the second data packet; and receive the second data packet based on the configuration information.

In some possible implementations, the configuration information includes at least one of the following: a G-RNTI corresponding to the third MBMS, time domain location information for receiving the second data packet, and frequency domain location information for receiving the second data packet.

Based on a same concept, an embodiment of this application provides a network device. The network device includes a processor and a memory. The processor is coupled to the memory. The processor is configured to read and execute instructions in the memory, to implement the data transmission method according to the first aspect, the third aspect, and the possible implementations of the first aspect and the third aspect.

Based on a same concept, an embodiment of this application provides a network device. The network device includes a processor and a memory. The processor is coupled to the memory. The processor is configured to read and execute instructions in the memory, to implement the data transmission method according to the second aspect and the possible implementations of the second aspect.

Based on a same concept, an embodiment of this application provides a computer-readable storage medium. The computer-readable storage medium stores instructions. When the instructions are run on a computer, the instructions are used to perform the data transmission method according to any one of the first aspect to the third aspect.

Based on a same concept, an embodiment of this application provides a computer program or a computer program product. When the computer program or the computer program product is executed on a computer, the computer is enabled to implement the data transmission method according to either of the first aspect and/or the third aspect.

A person skilled in the art can understand that functions described with reference to various illustrative logical blocks, modules, and algorithm steps disclosed in this specification may be implemented by using hardware, software, firmware, or any combination thereof. If implemented by software, the functions described with reference to the illustrative logical blocks, modules, and steps may be stored in or transmitted over a computer-readable medium as one or more instructions or code and executed by a hardware-based processing unit. The computer-readable medium may include a computer-readable storage medium, which corresponds to a tangible medium such as a data storage medium, or a communication medium that includes any medium that facilitates transmission of a computer program from one place to another (for example, according to a communication protocol). In this manner, the computer-readable medium may generally correspond to: (1) a non-transitory tangible computer-readable storage medium, or (2) a communication medium such as a signal or a carrier. The data storage medium may be any usable medium that can be accessed by one or more computers or one or more processors to retrieve instructions, code, and/or data structures for implementing the technologies described in this application. A computer program product may include a computer-readable medium.

By way of example, and not limitation, such computer-readable storage media may include a random access memory (RAM), a read-only memory (ROM), an electrically erasable programmable ROM (EEPROM), a compact-disc-ROM (CD-ROM) or another optical disc storage apparatus, a magnetic disk storage apparatus or another magnetic storage apparatus, a flash memory, a solid-state drive, or any other medium that can store required program code in a form of instructions or a data structure and that can be accessed by a computer. In addition, any connection is properly referred to as a computer-readable medium. For example, if instructions are transmitted from a website, a server, or another remote source through a coaxial cable, an optical fiber, a twisted pair, a digital subscriber line (DSL), or wireless technologies such as infrared, radio, and microwave, the coaxial cable, the optical fiber, the twisted pair, the DSL, or the wireless technologies such as infrared, radio, and microwave are included in a definition of the medium. However, it should be understood that the computer-readable storage medium and the data storage medium do not include connections, carriers, signals, or other transitory media, but actually mean non-transitory tangible storage media. Disks and optical discs used in this specification include a CD, a laser disc, an optical disc, a digital versatile disc (DVD), and a Blu-ray disc. The disks usually reproduce data magnetically, and the optical discs reproduce data optically by using lasers. A combination of the foregoing items should also be included in the scope of the computer-readable medium.

The instructions may be executed by one or more processors such as one or more digital signal processors (DSP), a general microprocessor, an application-specific integrated circuit (ASIC), a field programmable gate array (FPGA), or other equivalent integrated or discrete logic circuits. Therefore, the term “processor” used in this specification may refer to any one of the foregoing structures or any other structure applicable to implementation of the technologies described in this specification. In addition, in some aspects, the functions described with reference to the illustrative logical blocks, modules, and steps described in this specification may be provided within dedicated hardware and/or software modules configured for encoding and decoding, or may be incorporated into a combined codec. In addition, the technologies may be completely implemented in one or more circuits or logic elements.

The technologies in this application may be implemented in various apparatuses or devices, including a wireless handset, an integrated circuit (IC), or a set of ICs (for example, a chip set). Various components, modules, or units are described in this application to emphasize functional aspects of the apparatuses configured to perform the disclosed technologies, but are not necessarily implemented by different hardware units. Actually, as described above, various units may be combined into a codec hardware unit in combination with appropriate software and/or firmware, or may be provided by interoperable hardware units (including the one or more processors described above).

In the foregoing embodiments, descriptions of each embodiment have respective focuses. For a part that is not described in detail in an embodiment, refer to related descriptions in other embodiments.

The foregoing descriptions are merely example implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A data transmission method, comprising:
receiving, by a first network device, a first data packet, wherein the first data packet is a data packet of a first multimedia broadcast multicast service (MBMS), and the first data packet carries first information; and
when second information of the first network device matches the first information, sending, by the first network device, the first data packet to a terminal device that accesses the first network device, wherein the second information comprises a configuration preconfigured for the first network device.

2. The method according to claim 1, wherein when the second information of the first network device matches the first information, the method further comprises:
sending, by the first network device, the first data packet to N second network devices, wherein N is a positive integer.

3. The method according to claim 2, wherein the method further comprises:
obtaining, by the first network device, N+1 first data packets based on the first data packet; and
sending, by the first network device, the N+1 first data packets to the terminal device and the N second network devices.

4. The method according to claim 1, wherein the method further comprises:
when second information of the first network device does not match the first information, sending, by the first network device, the first data packet to N second network devices, wherein N is a positive integer.

5. The method according to claim 4, wherein the sending, by the first network device, the first data packet to N second network devices comprises:
obtaining, by the first network device, N first data packets based on the first data packet; and
sending, by the first network device, the N first data packets to the N second network devices.

6. The method according to claim 4, wherein when the second information of the first network device does not match the first information, the method further comprises:
when a next-hop network device of the first network device is unavailable, discarding, by the first network device, the first data packet.

7. The method according to claim 1, wherein each of the N second network devices are all next-hop network devices of the first network device.

8. The method according to claim 1, wherein the first information comprises at least one of a routing address corresponding to the first MBMS or a service identifier of the first MBMS; and
the second information comprises at least one of a routing address configured for the first network device or a service identifier of a second MBMS.

9. The method according to claim 8, wherein the first information further comprises a path identifier; and
the method further comprises determining, by the first network device, the N second network devices based on the path identifier.

10. The method according to claim 9, wherein the method further comprises:
obtaining, by the first network device, third information indicating a mapping relationship between the path identifier and a second network device of the N second network devices; and
the determining, by the first network device, the N second network devices based on the path identifier comprises:
determining, by the first network device, the N second network devices based on the path identifier and the third information.

11. The method according to claim 1, wherein before the sending, by the first network device, the first data packet to the terminal device, the method further comprises:
indicating, by the first network device, an internet protocol (IP) layer not to perform first processing on the first data packet, wherein the first processing comprises screening the first data packet based on an IP address carried in the first data packet or discarding the first data packet; or
modifying, by the first network device, an IP address of the first data packet to a first IP address, wherein the first IP address is an IP address preconfigured for the first network device.

12. The method according to claim 1, wherein the sending, by the first network device, the first data packet to the terminal device comprises:
obtaining, by the first network device, third information comprising a multicast internet protocol (IP) address configured for the first network device; and
sending, by the first network device, the first data packet to the terminal device based on the multicast IP address.

13. A data transmission method, comprising:
configuring, by a first network device, corresponding first information for a first data packet of a first multimedia broadcast multicast service (MBMS); and
sending, by the first network device, the first data packet to a second network device, wherein the first data packet carries the first information, and the first information triggers the second network device to perform at least one of the following operations: sending the first data packet to a terminal device that accesses the second network device, sending the first data packet to N third network devices, or discarding the first data packet.

14. The method according to claim 13, wherein the method further comprises:
configuring, by the first network device, second information for the second network device, wherein the second information corresponds to a second MBMS.

15. The method according to claim 13, wherein the second information comprises at least one of a routing address configured for the second network device or a service identifier of the second MBMS service.

16. A data transmission method, comprising:
Receiving, by a first network device in a unicast or a multicast mode, a first data packet sent by a second network device, wherein the first data packet is a data packet of a first multimedia broadcast multicast service (MBMS); and
sending, by the first network device in the unicast or the multicast mode, the first data packet to at least one of a third network device or a terminal device that accesses the first network device.

17. The method according to claim 16, wherein the receiving, by the first network device in the multicast mode, the first data packet sent by a second network device comprises:
obtaining, by the first network device, configuration information corresponding to the first data packet; and
receiving, by the first network device, the first data packet based on the configuration information.

18. A network device, comprising a processor and a memory, wherein the processor is coupled to the memory; and the processor is configured to read and execute instructions in the memory, to implement the data transmission method according to claim 1.

19. A network device, comprising a processor and a memory, wherein the processor is coupled to the memory; and the processor is configured to read and execute instructions in the memory, to implement the data transmission method according to claim 13.

20. A network device, comprising a processor and a memory, wherein the processor is coupled to the memory; and the processor is configured to read and execute instructions in the memory, to implement the data transmission method according to claim 16.
